(19) United States
(12) Patent Application Publication
(10) Pub. No.: US 2026/0100323 A1
(43) Pub. Date: Apr. 9, 2026

(54) ROTATING ANODE DISK ASSEMBLIES

(71) Applicant: IXRF, Inc., Austin, TX (US)

(72) Inventor: Robert Clayton Tisdale, Austin, TX (US)

(73) Assignee: IXRF, Inc., Austin, TX (US)

(21) Appl. No.: 19/350,884

(22) Filed: Oct. 6, 2025

Related U.S. Application Data
(60) Provisional application No. 63/704,141, filed on Oct. 7, 2024.

(51) Int. Cl. H01J 35/10; H01J 35/18

(52) U.S. Cl. CPC H01J 35/106; H01J 35/1017; H01J 35/186; H01J 2235/081; H01J 2235/1053; H01J 2235/1204; H01J 2235/122; H01J 2235/183

(57) ABSTRACT

In some embodiments, a system may include an X-ray tube assembly having an anode disk assembly. The system may include a motor configured to rotate the anode disk assembly. The system may include one or more pumps configured to draw a vacuum in the X-ray tube assembly. The system may include a cooling system configured to cool the anode disk assembly. In some embodiments, a method may include drawing a vacuum in an X-ray tube assembly with one or more pumps. The method may include rotating an anode disk assembly of the X-ray tube assembly. The method may include cooling the anode disk assembly with a cooling system. The method may include activating a power supply to produce an electron beam. The electron beam may interact with an X-ray generating layer of the anode disk assembly to produce an X-ray beam oriented to impinge on a sample.

### CROSS-REFERENCE TO RELATED APPLICATIONS

This application claims priority to U.S. Provisional Patent Application No. 63/704,141 filed on Oct. 7, 2024, the entirety of which is incorporated herein by reference.

### FIELD OF DISCLOSURE

The disclosed systems and methods relate to the field of elemental analysis. More particularly, the disclosed systems and methods are concerned with cooling a transmission target of an X-ray tube.

### BACKGROUND

In the field of X-ray generation, the operational efficiency and reliability of X-ray tubes are important. X-ray tubes are electron beam generating devices that produce X-rays through the bombardment of a target material by a high-velocity electron beam. This process is inherently inefficient, with less than 1% of the electron beam energy being converted into X-rays, the remainder primarily manifesting as thermal energy. The thermal management of this energy is important to the functionality and longevity of X-ray tubes.

Traditional X-ray tubes comprise a vacuum vessel containing opposed electrodes: a cathode assembly and an anode assembly. The vacuum vessel is designed to house the electrodes in a manner that facilitates the efficient production of X-rays while managing the thermal loads generated during operation. The cathode emits electrons that are accelerated towards the anode target, where their kinetic energy is converted into X-rays and heat. The thermal energy generated, particularly at the anode target, can reach temperatures up to approximately 2700° C., necessitating robust cooling mechanisms to prevent damage like localized melting and pitting of the anode target and to ensure operational reliability.

Only a very small fraction of the kinetic energy of the electrons is converted to high energy electromagnetic radiation, or X-rays, while the balance is contained in back scattered electrons or converted to heat. Ultimately, the back scattered electrons are absorbed by components within the vacuum vessel as heat energy. The X-rays are emitted in all directions, emanating from the focal spot, and may be directed out of the vacuum vessel through an X-ray transparent window.

Several challenges arise in the management of thermal energy within X-ray tubes. For instance, the dissipation of heat from the anode target is a concern, given the high temperatures achieved during operation. In one solution, a massive anode rotor spins to distribute the heat load over a larger target area, supplemented by cooling channels within the rotor through which coolant is circulated. An annular anode target on the surface of the rotor rapidly spins while different regions of target along the circular track are sequentially irradiated by the electron beam, thereby distributing the heat load over the large area of the track. However, this solution introduces additional complexities, such as the need for periodic rebalancing of the heavy anode, rotating seals to maintain vacuum conditions, and the challenge of lubricating bearings without conventional lubricants that would vaporize under vacuum conditions.

The efficiency of X-ray production and the associated thermal management may be further complicated by the demands of modern imaging techniques, such as fast helical scanning in computed tomography, which require higher X-ray fluxes and thus impose greater thermal loads on the X-ray tube components. The conventional approach to thermal management in X-ray tubes, which includes radiating heat from the anode to the vacuum vessel and removing it via circulating cooling fluid, is increasingly inadequate for meeting the demands of high-performance X-ray imaging systems.

Given these challenges, there is a recognized need for advancements in the thermal management of X-ray tubes. Improved cooling methods and systems are essential, not only for enhancing the performance and reliability of X-ray tubes, but also for enabling higher power outputs and faster imaging capabilities. There is a compelling need for innovations in X-ray tube design that allow for more effective heat dissipation from the anode, facilitate cooler operation, and enable faster heat transfer, thereby increasing the overall power and reliability of X-ray tube systems.

### SUMMARY

In some embodiments, a system may include an X-ray tube assembly having an anode disk assembly. The system may include a motor configured to rotate the anode disk assembly. The system may include one or more pumps configured to draw a vacuum in the X-ray tube assembly. The system may include an open-loop cooling system configured to cool the anode disk assembly.

In some embodiments, the anode disk assembly may include a support window made of a metal material such that the support window may be configured to generate X-rays from an electron beam incident on the support window. In some embodiments, the anode disk assembly may include a support window and an X-ray generating layer having a target spot. In some embodiments, the system may include a power supply and a slip ring coupled to the X-ray generating layer. The power supply may be configured to provide power to a filament cathode of the X-ray tube assembly and the slip ring. In some embodiments, the open-loop cooling system may include a nozzle, a refrigeration generator, and a tube coupling the nozzle to the refrigeration generator. The nozzle may provide a cooling medium to a surface of the support window from the refrigeration generator. In some embodiments, the X-ray tube assembly may be oriented such that an anode inclination (AI) and an X-ray emission (XE) angle are both zero degrees. In some embodiments, the X-ray tube assembly may include a ferrofluidic seal configured to maintain the vacuum in the X-ray tube assembly while the anode disk assembly is rotating. In some embodiments, the anode disk assembly may include an inner bearing race and an insulating ring. The insulating ring may be vacuum bonded to the inner bearing race and a support window of the anode disk assembly.

In some embodiments, a system may include an X-ray tube assembly having an anode disk assembly. The system may include a motor configured to rotate the anode disk assembly. The system may include one or more pumps configured to draw a vacuum in the X-ray tube assembly. The system may include a closed-loop cooling system configured to cool the anode disk assembly.

In some embodiments, the anode disk assembly may include a support window made of a metal material such that the support window may be configured to generate X-rays from an electron beam incident on the support window. In some embodiments, the anode disk assembly may include a support window and an X-ray generating layer having a target spot. In some embodiments, the system may include a power supply and a slip ring coupled to the X-ray generating layer. The power supply may be configured to provide power to a filament cathode of the X-ray tube assembly and the slip ring. In some embodiments, the closed-loop cooling system may include a refrigerator and a dispenser coupled to the refrigerator. The dispenser may provide a cooling medium to a surface of the support window from the refrigerator. The X-ray tube assembly may be configured such that the cooling medium may be directed back to the refrigerator after being dispensed by the dispenser. In some embodiments, the X-ray tube assembly may be oriented such that an anode inclination (AI) and an X-ray emission (XE) angle are both zero degrees. In some embodiments, the X-ray tube assembly may include a ferrofluidic seal configured to maintain the vacuum in the X-ray tube assembly while the anode disk assembly is rotating. In some embodiments, the anode disk assembly may include an inner bearing race and an insulating ring. The insulating ring may be vacuum bonded to the inner bearing race and a support window of the anode disk assembly.

In some embodiments, a method may include drawing a vacuum in an X-ray tube assembly with one or more pumps. The method may include rotating an anode disk assembly of the X-ray tube assembly. The method may include cooling the anode disk assembly with a cooling system. The method may include activating a power supply to produce an electron beam. The electron beam may interact with an X-ray generating layer of the anode disk assembly to produce an X-ray beam oriented to impinge on a sample.

In some embodiments, the method may include focusing the electron beam with a focusing cup. In some embodiments, the method may include steering the electron beam with optics disposed in a path of the electron beam. In some embodiments, the method may include securing power to the X-ray tube assembly in response to a loss of cooling of the cooling system.

### BRIEF DESCRIPTION OF THE DRAWINGS

The features and advantages of the present disclosure will be more fully disclosed in, or rendered obvious by, the following detailed descriptions of example embodiments. The detailed descriptions of the example embodiments are to be considered together with the accompanying drawings wherein like numbers refer to like parts and further wherein:

FIG. 1 illustrates one example of an X-ray tube assembly having an open-loop cooling system in accordance with some embodiments;

FIG. 2 illustrates one example of an X-ray tube assembly having a closed-loop cooling system in accordance with some embodiments;

FIG. 3 illustrates a perspective view of a portion of one example of an X-ray tube assembly in accordance with some embodiments;

FIG. 4 illustrates a block diagram of one example of a computing device of an X-ray tube assembly in accordance with some embodiments; and

FIG. 5 illustrates one example of a method of X-ray generation in accordance with some embodiments.

While the present disclosure is susceptible to various modifications and alternative forms, specific embodiments have been shown by way of example in the drawings and will be described in detail herein. It should be understood, however, that the present disclosure is not intended to be limited to the particular forms disclosed. Rather, the present disclosure is to cover all modifications, equivalents, and alternatives falling within the spirit and scope of the disclosure as defined by the appended claims.

### DETAILED DESCRIPTION

This description of the exemplary embodiments is intended to be read in connection with the accompanying drawings, which are to be considered part of the entire written description. It should be understood, however, that the present disclosure is not intended to be limited to the particular forms disclosed and that the drawings are not necessarily shown to scale. Rather, the present disclosure covers all modifications, equivalents, and alternatives that fall within the spirit and scope of these exemplary embodiments. In the description, relative terms such as “lower,” “upper,” “horizontal,” “vertical,” “above,” “below,” “up,” “down,” “top,” and “bottom” as well as derivatives thereof (e.g., “horizontally,” “downwardly,” “upwardly,” etc.) should be construed to refer to the orientation as then described or as shown in the drawing under discussion. These relative terms are for convenience of description and do not require that the apparatus be constructed or operated in a particular orientation. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise. The terms “couple,” “coupled,” “operatively coupled,” “operatively connected,” and the like should be broadly understood to refer to connecting devices or components together either mechanically, or otherwise, such that the connection allows the pertinent devices or components to operate with each other as intended by virtue of that relationship.

### Overview

The present disclosure generally relates to methods and apparatuses for generating X-ray radiation, especially with high brilliance and a micron scale emission focal spot. The present disclosure is related generally to vacuum tubes having rotating anodes bombarded by energetic electrons and, more particularly to an X-ray method and X-ray tube employing an actively cooled transmission target rotating anode disk. The generated X-radiation may, for example, be used in: medical diagnostics, non-destructive testing, lithography, microscopy, computed tomography, medical and industrial radiography, materials science, semiconductor metrology, X-ray crystallography, X-ray fluorescence, or X-ray diffraction just to provide a few non-limiting examples.

In some embodiments, a system is disclosed having a rotating disk transmission target anode X-ray source and a cooling system that is configured to efficiently cool the electron beam target surface. An X-ray tube assembly may include an X-ray tube vacuum envelope, a cathode assembly, and a transmission anode assembly. The transmission anode assembly may include an X-ray generation layer target and an anode substrate. The X-ray generation layer target may be annular or circular, and may be mounted on a rotating disc-shaped anode substrate. The anode disk assembly may be configured to receive electron energy at the X-ray generation layer and to emit X-rays through the anode substrate. The provision of a transmission anode facilitates, among other things, improved X-ray yield and power.

In some embodiments, the transmission anode may have an anode material (e.g., Rh, W, etc.) deposited as a uniform layer onto a thin diamond substrate disk transmission anode, facilitating high thermal conductivity. In other embodiments, materials such as beryllium (Be) or other metals could also serve as a disk substrate material. In some embodiments, an anode assembly may include an X-ray generation layer disposed on the anode substrate and may be configured to have an anode inclination angle and an X-ray emission angle that are both about zero degrees.

In some embodiments, energy may be removed from the rotating anode disk target by a conductive process which involves continuous cooling of the non-vacuum surface of the disk. For example, the disk may be spun at high revolutions per unit time (e.g., revolutions per minute (RPM)) while being irradiated with electrons on the target side inside the vacuum envelope while simultaneously cooled on the opposite non-vacuum side of the anode substrate disk material. The rotation of the disk at high RPM effectively presents a large surface area for cooling. In some embodiments, the cooling system may employ either an open-loop or closed-loop cycle that uses a cooling medium, such as cryogenic gas or liquid, to cool the non-vacuum side of the thin anode disk.

In some embodiments, the rotating disk and cooling system may facilitate the transfer of a tremendous amount of heat quickly, enabling high wattage X-ray production with small focal spots. In some embodiments, vacuum confinement for the high vacuum tube volume may be accomplished with a turbo molecular pump and ferrofluidic seals for the rotating anode disk. In some embodiments, the X-ray tube may include an actively pumped high vacuum X-ray envelope housing both the cathode assembly and the anode assembly.

The transmission anode, comprising the X-ray generation layer and the anode substrate, may be configured to receive accelerating electrons from the cathode, generating X-rays due to the interaction between the electrons and the X-ray generation layer material. These X-rays may pass through the anode substrate, and optionally through an X-ray optical assembly, to form an emergent X-ray beam composed of the characteristic X-ray fluorescent lines of the anode target material and a broad band continuum of X-ray light called Bremßtrahlung radiation. The electron beam may impact the X-ray generating layer perpendicularly, and the forward-directed X-rays may pass through both the X-ray generating layer and the substrate to emerge as a beam that may be further conditioned or modified by metal foil filters and X-ray optics.

In some embodiments, the transmission anode assembly may rotate about a central axis. The rotating anode disk may be one of various suitable geometries, such as a circular disc with an annular or circular X-ray generation layer. This rotating disc configuration may help distribute the heat load across a larger focal track area, enhancing thermal management and allowing for higher power operation.

Unlike other transmission target rotating anode X-ray tubes, the rotating anode X-ray tube disclosed herein does not solely rely on the Stephan-Boltzman law for the cooling process. Rather active conduction cooling of a thin low-mass rotating disk assembly may be used.

Heat dissipation for X-ray tube anodes may be modeled in a few different ways. While not necessarily comprehensive, three approaches are illustrated: Fourier's law of heat conduction, Oosterkamp's power limitation equation, and the Stefan-Boltzmann law.

The rate of heat flow (conduction) is the amount of heat that is transferred per unit of time in some material, usually measured in watts (joules per second). The equation of heat flow may be given by Fourier's Law of Heat Conduction. Rate of heat flow is always negative and is the heat transfer coefficient times the area of the object times the variation of the temperature divided by the thickness of the material. Thus, the formula for the rate of heat flow (Q), based on simplified Fourier's Law in one dimension (1D) may be given by Equation 1 below:

$$Q = ( - \frac{λ \cdot A \cdot Δ T}{Δ x} ) \qquad ( Equation 1 )$$

$$Where :$$

$$Q = rate of heat transfer ( W ) ;$$

$$λ = thermal conductivity of anode material ( W / cmK ) ;$$

$$A = area of thermal load ( anode hot spot area in {cm}^{2} ) ;$$

$$Δ T = change of temperature ( K ) ; and$$

$$Δ x = anode disk thickness , in cm .$$

In some embodiments, a target spot at a radius of 0.85 cm from the center of the anode support disk may afford a circumference of: C=2πr=2 (3.14)(0.85)=5.34 cm linear traverse. With a target spot of 50 μm and 5.34 cm traverse, the number of spots on this anode is equal to the traverse divided by spot size: 5.34 cm/0.005 cm/spot=1068 spots. Therefore, 1068spots/revolution·1000 rpm/60spm=17,800 spots/s. The reciprocal affords a dwell of 5.618e−5 s/spot.

Relative to Q for this disclosure, the following assumptions may be made:

$${λ}_{( CVD diamond )} = 18 W / cmK , about 5 X that of Copper ( Cu ) ;$$

$$A = 1. 964 e - 5 {cm}^{2} , for a 50 μm ( 0.005 cm ) diameter spot ;$$

$$Δ T = 2 \; 377 - 77 = 2300 K ;$$

$$Δ x = 100 μm = 0.01 cm ; and$$

$$Δ t = 5 \text{.618} e - 5 s dwell for 2 cm diameter anode at 1000 rpm ;$$

2377K for a tungsten (W)-target limit based upon not exceeding the 1500° C. graphitization limit of diamond at the W-diamond interface, although as this is in a vacuum, this limit may be exceeded. A temperature of 77K may be used for the cooling medium, such as liquid nitrogen (LN₂), but could be as low as 4K with other cooling systems, such as Gifford-McMahon cycle closed loop refrigeration. Thus, Q=−(18 W/cmK·1.964e−5 cm². 2300K)/0.01 cm=0.8131Wcm/0.01 cm=−81 W.

Time rate of heat flow (TRHF) is the net heat transfer for a given time, which may be given by Equation 2 below:

$$T R H F = \frac{Q}{Δ t} \qquad ( Equation 2 )$$

$$Where :$$

$$Q = rate of heat transfer ( W ) ; and$$

$$Δ t = change in time .$$

$$Thus , T R H F = Q / Δ t = - 81 W / 5.618 e - 5 s = - 1.44 e6 W / s .$$

In this example, the result is a large number validating the efficacy of the systems and methods disclosed herein.

For short exposure times and a stationary anode, the maximum temperature difference ΔTₘₐₓ between the temperature at the center of the focus on the anode surface and the mean temperature Tₐᵥₑ, of the anode may be given by Equation 3 below:

$$Δ {T}_{max} = 2 W \sqrt{\frac{t}{πλρ c}} \qquad ( Equation 3 )$$

$$Where :$$

$$W = specific anode load in W / {m}^{2}$$

$$t = time of exposure in seconds ;$$

$$λ = the thermal conductivity ;$$

$$ρ = density ; and$$

$$c = specific heat .$$

This equation may be rearranged and modified to solve for power of a reflection type rotating anode X-ray tube, which may yield the Oosterkamp power limitation given by Equation 4 below:

$$P = \frac{Δ T \cdot A \sqrt{π \cdot λ \cdot p \cdot c}}{2 \cdot \sqrt{t}} \qquad ( Equation 4 )$$

$$Where :$$

$$P = the power , representing the rate of heat transfer ( W ) ;$$

$$Δ T = the temperature difference across the material ( K ) ;$$

$$A = the linear equivalent active area ( {m}^{3} ) ;$$

$$λ = the thermal conductivity of the material ( W / mK ) ;$$

$$ρ = the density of the material ( kg / m 3 ) \text{;;}$$

$$c = the specific heat of the material ( J / kgK ) ; and$$

$$t = b / v π D ,$$

where:
   b is the width (m) of the focus;
   ν is the frequency of rotation (per second); and
   D is the mean diameter (m) of the anode focus path.

With the following assumptions, it is possible to solve the equation for some embodiments of this disclosure:

$${λ}_{( CVD diamond )} = 1800 W / mK , about 5 X that of Cu ;$$

$$A = annulus area for 50 μm spot and OD of 2 cm = 3.132 e - 6 {m}^{2} ;$$

$$c = specific heat CVD diamond = 0.502 J / kgK ;$$

$$ρ = density of CVD diamond = 3520 kg / {m}^{3} ;$$

$$Δ T = 2377 - 77 = 2300 K ( for {LN}_{2} cooling ) ;$$

$$t = b / ( v \cdot π \cdot D ) = 50 e - 5 / ( 1000 \cdot π \cdot 0.00995 ) = 1.6 e - 6$$

$$Thus , P = ( ( 2300 \cdot 3.132 e - 6 ) \cdot SQRT ( 3.14 \cdot 1800 \cdot 3520 \cdot 0.502 ) ) / ( 2 \cdot SQRT ( 1.6 e - 6 ) ) = 22 \text{.80} / 0.002529 \approx 9 kW .$$

As the disclosure describes a transmission target rotating anode, and not a reflection target design, the 9 kW value may be the lower bound of power generation for a predominately conduction cooled X-ray tube design. The Oosterkamp Equation also does not take into account the thinness of the transmission support disk and the previously described time rate of heat flow.

In a high vacuum X-ray tube, the heat transfer from the anode to the tube assembly may primarily occur through infrared radiation, which can be quantified using the Stefan-Boltzmann law. Equation 5 below may describe this process as:

$$Q = ϵσ A Δ {T}^{4} F \qquad ( Equation 5 )$$

Where:
Q represents the heat transfer rate in watts (W);
ϵ is the emissivity of the radiating surface;
σ is the Stefan-Boltzmann constant;
A is the area of the radiating surface;
ΔT is the temperature of the radiating surface; and
F is the form factor.

With the following assumptions, it is possible to solve the equation for some embodiments of this disclosure:

$$ϵ = emissivity = 0.3 for CVD diamond$$

$$A = anode area = 3.132 e - 6 {m}^{2} , for a 50 μm spot in an annulus$$

$$σ = SF constant = 5.67 e - 8 W / {m}^{2} {K}^{4}$$

$$F = 1 ( placeholder assumption )$$

$$Δ T = 2 \; 377 - 77 = 2300 K$$

$$Thus , P = 0.3 \cdot ( 567 e - 8 ) \cdot ( 3.132 e - 6 ) \cdot {( 2300 )}^{4} \cdot 1 = 1.5 W$$

These calculations provide confirmation for the underlying premises of this disclosure, confirming that the time rate of heat flow (TRHF) and Oosterkamp power limitation calculations are favorable for removing a large amount of heat from the rotating disk assembly via conduction. Furthermore, the Stefan-Boltzmann law calculation projects only a small 1.5 W of infrared radiation, which may be emitted as radiative heat transfer, confirming that cooling requirements for the tube envelope and wide-bore, hollow-shaft, ferrofluidic seal rotating feedthrough would be minimal.

As an example, with voltage in the range of 100 to 300 kV, transmission anode X-ray tubes may demonstrate X-ray yields approximately two times (2×) greater than those of conventional reflection anode X-ray tubes. Transmission anodes also offer a smaller focal spot size while reducing or eliminating focal spot blooming, a common issue with reflection anode X-ray tubes. Furthermore, transmission anode geometries achieve larger vertex angles for cone-shaped X-ray beams, up to 90 degrees, without the anode heel effect limitations of reflection anode tubes. A variety of other significant benefits from a transmission target rotating anode disk design may be inferred from the cited literature in U.S. Provisional Patent Application No. 63/704,141 already incorporated herein by reference (e.g., U.S. Pat. No. 7,978,824 and Wang, S. F., et al. “Respective radiation output characteristics of transmission-target and reflection-target X-ray tubes with the same beam quality.” Radiation Physics and Chemistry 158 (2019) 188-193), including the production of a highly parallelized X-ray photon beam that may be suited to mating with a variety of popular X-ray optical systems.

In some embodiments, the rotational mass of the rotating anode disk assembly may be measured in grams, rather than kilograms. The centripetal forces, due to high masses at high rotational speed, may be significantly reduced to a more manageable level of less than a few hundred grams for the rotating disk assembly. This reduction in mass may translate to a diminution of forces resulting in longer tube lifetimes, greatly reduced or eliminated anode balancing requirements, increased bearing lifetimes and generally less frequent maintenance.

Overall, the transmission anode rotating disk X-ray tubes described herein offer numerous advantages, including higher X-ray yields, smaller focal spot sizes, and the ability to handle higher electron peak input power for pulsed X-ray beams.

### DETAILED DESCRIPTION OF THE DRAWINGS

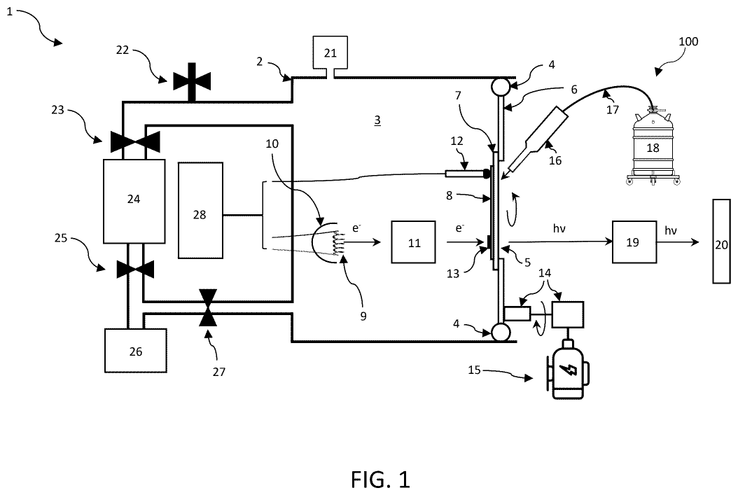

Referring now to the drawings, FIG. 1 illustrates one example of an X-ray tube assembly 1 having an open-loop cooling system 100 in accordance with some embodiments. The X-ray tube assembly 1 may include an X-ray tube body 2 that defines a vacuum area 3 and a seal 4. The X-ray tube assembly 1 may include a rotating anode disk assembly 5 having an insulating ring 6, a support window 7, and an X-ray generation layer 8. The X-ray tube assembly 1 may include a cathode filament 9, a focusing cup 10, steering optics 11, and a high-voltage slip ring 12 (or brush). The generation layer 8 may define an X-ray emitting target spot 13. The X-ray tube assembly 1 may include a drive assembly comprising a drive 14 (e.g., one or more gears or transmission) and a motor 15. The open-loop cooling system 100 may include a nozzle 16 disposed adjacent to the rotating anode disk assembly 5 and tubing connecting the nozzle 16 to a refrigeration generator 18. The X-ray tube assembly 1 may be configured to direct the generated X-rays to an X-ray optic 19 in route to a sample 20. The X-ray tube assembly 1 may include gauge 21 to determine the pressure/vacuum in the vacuum area 3. Vacuum may be drawn in the vacuum area 3 of the X-ray tube assembly 1 using an air admit valve 22, a high-vacuum valve 23, a turbomolecular pump 24, a backing valve 25, a roughing pump 26, and a roughing valve 27. Components of the X-ray tube assembly 1 (e.g., the cathode filament 9 and the slip ring (or brush) 12 may be powered by a high volt power supply (HVPS) 28.

As discussed above, the X-ray tube assembly 1 may include a body 2 that defines a vacuum area 3, which may be configured to have a high-vacuum atmosphere within the body 2. The actively pumped open-style X-ray tube body 2 may include the anode disk assembly 5 and the cathode filament 9 configured to emit an external divergent primary X-ray beam (hv) through the target spot 13 on the generation layer 8. The X-ray emissions may pass through an actively cooled X-ray transparent support window 7 before leaving the X-ray tube body 2 where the X-rays may be further refined through the use of X-ray optics 19 before impinging on the sample 20.

In some embodiments, the anode disk assembly 5 may be a round and generally planar multi-part device comprised of a thermally insulating ring 6 high-vacuum bonded to a wide-bore, hollow-shaft, ferrofluidic seal 4 feedthrough on the outside of the ring while the inner annulus ring may be high-vacuum bonded to an X-ray transparent support window 7 to complete the vacuum seal. In some embodiments, the ferrofluidic seal 4 feedthrough may be model RMS-HS from Rotary Vacuum Products, Inc. of Salem, NH.

In some embodiments, the target spot 13 on the generation layer 8, supported by an actively cooled X-ray transparent support window 7, may be displaced as far as possible from the center of the anode disk assembly 5 so as to provide maximum integrated target area, and hence maximum conduction and dissipation of heat.

In some embodiments, the support window 7 may be metallic and form the generation layer 8 in and of itself (i.e., there would be no need for the X-ray generation layer 8). In some embodiments, the X-ray transparent support window 7 may be composed of a diamond coat and may be disposed adjacent or abutting the metal X-ray generation layer 8. For example, the support window 7 may be a tungsten-coated chemical vapor deposition (CVD) diamond window product of the Diamond Materials company from Freiberg, Germany. Diamond plays two roles in that it acts as an efficient heat spreader that rapidly dissipates the heat from the target spot 13 while serving as a strong and rigid X-ray transparent support window 7.

In some embodiments, the X-ray transparent support window 7 may be a material other than diamond, such as beryllium (Be), a composite material, or some sufficient synthetic material. For example, the support window 7 may be a window provided by Moxtek, Inc. of Orem, UT. It will be appreciated that other suitable materials may include various forms of silicon carbide, beryllium oxide, aluminum nitride, aluminum oxide, graphene, graphite, or windows made from various fullerenes just to provide a few non-limiting examples.

In some embodiments, the X-ray transparent support window 7 may be supported on the outside of the body 2 (i.e., the non-vacuum side) by some rigid or semi-rigid grid or truss structure as needed against failure caused by pressure differentials between the vacuum in the vacuum area 3 inside the X-ray tube body 2 and the external atmosphere outside of the body 2.

In some embodiments, metamaterials may be employed to create either or both of the X-ray generation layer 8 and the X-ray transparent anode support window 7 as well as other aspects of tube assembly pertaining to advanced materials and structures involved in rapid heat transfer. Metamaterials are composite structures engineered to exhibit electromagnetic properties not found in naturally occurring materials. Specifically, these properties are derived from the metamaterial's unique arrangement and geometry of its constituent elements, which are typically sub-wavelength in size. The defining characteristic of a metamaterial is its ability to manipulate electromagnetic waves in unconventional ways. These effects are achieved by configuring the metamaterial to possess an effective negative index of refraction, anisotropy, or other tailored electromagnetic responses that arise from the collective interaction of its artificially structured components rather than from the material properties of its individual elements.

Furthermore, a high thermal conductivity metamaterial is an engineered composite structure designed to exhibit exceptional thermal conductive properties beyond those found in natural materials. This may be achieved through the strategic arrangement and geometric configuration of its micro- or nano-scale constituents, which synergistically enhance the effective thermal conductivity of the metamaterial. By incorporating materials with high intrinsic thermal conductivities and optimizing the interface and contact resistance between them, these metamaterials can guide and manage heat flow with unprecedented efficiency. The unique design of these structures allows for tailored anisotropic thermal conduction, enabling applications in thermal management systems, heat exchangers, and advanced electronic cooling solutions where controlled and efficient heat dissipation is important.

Examples of high thermal conductivity metamaterials include: (1) graphene-based metamaterials, where graphene's high intrinsic thermal conductivity can be leveraged in composites and layered structures to enhance overall thermal transport; (2) diamond-like carbon (DLC) films, where the films combine high thermal conductivity with excellent mechanical properties and are used in high-performance applications; and (3) metal-organic frameworks (MOFs), where MOFs with high thermal conductivity are engineered through precise control of their crystalline structures.

In some embodiments, the support window 7 may include a metallic X-ray generation layer 8 disposed on or above the support window 7 within the vacuum environment of the vacuum area 3. It is to be appreciated that describing the X-ray generation layer 8 as being disposed on the anode support window 7 is meant to include the X-ray generation layer 8 being directly attached, connected, or otherwise bonded to the support window 7, as well as the X-ray generation layer 8 being disposed on the anode support window 7 with one or more intervening layers, e.g., adhesive layers, filter layers or the like, between the X-ray generation layer 8 and the anode support window 7.

In some embodiments, the anode includes a thin X-ray generation layer 8 of metal disposed on a thicker anode support window 7. The thickness of the X-ray generation layer 8 may be chosen to provide the maximum X-ray output through the anode as a consequence of the competing effects of X-ray production and attenuation in the anode material. In some embodiments, the X-ray generation layer 8 may be between ≤100 nm to ≥100 μm thick. In some embodiments, the X-ray generation layer 8 may be between <1 micron to about 25 microns. One of ordinary skill in the art will understand that the X-ray generation layer 8 may have other thicknesses beyond these ranges. The substrate material may also provide filtration to improve X-ray beam (hv) spectral characteristics.

In some embodiments, the X-ray generation layer 8 may be comprised of refractory metals. In some embodiments, anode metals may include niobium (Nb), chromium (Cr), molybdenum (Mo), tantalum (Ta), tungsten (W), rhenium (Re), vanadium (V), hafnium (Hf), titanium (Ti), zirconium (Zr), ruthenium (Ru), osmium (Os), rhodium (Rh), silver (Au), gold (Au), palladium (Pd), copper (Cu), iron (Fe), cobalt (Co), iridium (Ir), or some combination thereof just to provide a few non-limiting examples.

Under the influence of high voltages, such as between 4-500 KV, produced by the integrated HVPS 28 in the high-vacuum environment of the vacuum area 3, thermionic electrons boiling off the heated cathode filament 9 are focused by the focusing cup 10 and the electron steering optics 11 while accelerated by the electric field (generally 4-300 kV) under the high vacuum environment in the vacuum area 3 toward the target spot 13 on the anode disk assembly 5. This produces or otherwise generates X-rays (hv) due to the interaction between the accelerating electrons (e⁻) and the material of the X-ray generation layer 8, where the generated X-rays pass through the anode disk assembly 5 comprised of the X-ray generation layer 8 and the anode support window 7. High voltage at the X-ray generation layer 8 may be maintained by a high-voltage slip ring 12 (or brush), or other similar electro-mechanical mechanism.

In some embodiments, the beam of accelerating electrons (e) has normal or near normal incidence on the X-ray generation layer 8, and the X-rays emitted in the forward direction from the X-ray emitting target spot 13 pass through the X-ray generation layer 8 and through the anode support window 7 to form the emergent X-ray beam outside the vacuum area 3 of the X-ray tube body 2. It will be appreciated that the anode disk assembly 5 may be referred to as a transmission anode because X-rays essentially pass or otherwise are transmitted through the anode, as opposed to merely reflecting off the anode.

In some embodiments, the process of power transmission in rotating electrical connectors begins at the HVPS source 28 attached to the stationary part of the tube assembly. Electrically conductive brushes, which may be made from carbographitic, electrographitic, soft graphite, metal graphite, Bakelite-graphite materials, or other suitable material may also be connected to the stationary part of the X-ray tube assembly 1. This rotating electrical connection, or slip ring 12, may be a rotary electrical connector, a rotating connector, a slip ring rotating connector, a rotating cable connector, a swivel wire connector, a rotary joint electrical connector, a rotating power connector, a rota connector, a slip ring rotary joint electrical connector, or a rotating electrical connector slip ring. From the HVPS 28, the electrical power enters the brushes or slip ring 12, which are maintained in constant contact with the conductive track or ring area on the anode X-ray generation layer 8. As the anode disk assembly 5 spins, the high voltage may be transferred via the rotating conductive tracks to the anode disk assembly 5. This mechanism allows for the transmission of electrical power between components, regardless of their motion relative to each other. Component rotation and power transmission can thus occur simultaneously without interference.

The geometric configuration of the cathode filament 9 and anode disk assembly 5, as well as any associated electron optics 11 for the X-ray tube, may be described by both the anode inclination (AI) angle and the X-ray emission (XE) angle. The AI angle may be defined as the angle between the axis of the incident electron beam and the normal to the anode surface, e.g., the normal to the surface of the X-ray generation layer 8. The XE angle may be defined as the angle between the axes of the incident electron beam and the emergent X-ray beam.

While some X-ray tubes exhibit an AI angle in the range of about 6 degrees to about 35 degrees and an XE angle of 20-90 degrees, the X-ray tube assembly 1 of the present disclosure may have an AI angle and an XE angle that may both be about 0 degrees. It will be appreciated that the provision of an XE angle of about 0 degrees is meant to include an XE angle of about 180 degrees, where the XE angle is measured between the axis of the incident electron beam and the emergent X-ray beam being transmitted through the anode disk assembly 5.

In some embodiments, the X-ray tube assembly 1 may be capable of providing an AI angle and an XE angle of about 0 degrees to facilitate a larger fraction of the X-rays emitted from the X-ray emitting target spot 13 on the X-ray generation layer 8 being transmitted through the anode disk assembly 5 and emerging from the tube body 2 through the anode support window 7.

In some embodiments, the direction of the emitted X-ray photons may be generally correlated with the direction of the electron beam striking the anode. This is due to the process of X-ray generation, which occurs when high-energy electrons from the cathode filament 9 strike the X-ray emitting target spot 13 in the X-ray generation layer 8 of the anode disk assembly 5. When electrons from the cathode 9 are accelerated towards the anode, they possess kinetic energy. Upon striking the anode material, which may be a heavy metal such as tungsten, the kinetic energy of the electrons may be converted into various forms, including thermal energy and X-ray photons. The X-ray photons may be emitted in various directions, but because there is a predominant directionality associated with the electron beam, a significant portion of the emitted photons will be directed along the path of the incident electron beam. This directional correlation between the electron beam and the emitted X-ray photons may be utilized to enhance the performance of the X-ray optics 19.

Centripetal acceleration (e.g., measured in grams) due to high rotational speed are diminished by up to three orders of magnitude, such as from 8500 g to a more manageable <100 g for the anode disk assembly 5 disclosed herein. Lower forces translate to longer tube lifetimes and lower regularly scheduled maintenance.

As discussed above, the open-loop cooling system 100 may include a dispenser nozzle 16, insulated tubing 17, and a refrigeration generator 18. The refrigeration generator 18 may be connected to the external side of the anode disk assembly 5 via insulated tubing 17 to a dispenser nozzle 16. In some embodiments, the refrigeration generator 18 may contain LN₂. In some embodiments, the dispenser nozzle 16 may be configured to emit 100K nitrogen gas. In some embodiments, the dispenser nozzle 16 may focus the cold stream onto a region of the external (i.e., non-vacuum) side of the X-ray transparent support window 7 without blocking the generated X-rays (hv) from the X-ray optic 19 or sample 20. Heat may be removed by a stream of a cooling medium, such as chilled, or cryogenic, gas or liquid directly impinging onto the external, non-vacuum side of the anode disk assembly 5. As an example, the open-cycle CryoStream 1000 or COBRA provided by Oxford Cryosystems Ltd. of Oxford, UK may be employed to provide LN₂ cooling with cryogenic N₂ gas at approximately 100K, for example. One of ordinary skill in the art will understand that other gasses and/or cooling temperatures may be used.

The flow rate and pressure of the cooling media may be monitored in real-time by one or more sensors connected to and/or controlled by a programmable logic controller (PLC) or computer system, such as computing device 200 discussed in more detail below, to ensure a consistent and adequate cooling stream. The PLC or computing system may also provide for an emergency stop of the X-ray tube assembly 1 should a cooling malfunction occur.

In some embodiments, the anode disk assembly 5 may be spun to some RPM, such as between 100-10,000 RPM, by the combination of the motor 15 and the drive 14 (e.g., one or more gears or transmission) to allow the motor 15 and drive 14 to function for extended periods of time, up to nearly a 100% duty cycle between regularly scheduled maintenance. The motor 15 may be one of a variety of types, such as electric, magnetic, turbine, pneumatic, hydraulic and so forth. The drive 14 may be, but not limited to, various types of gears, such as vane, rack-and-pinion, helical or some other type. Flex couplings and friction couplings may be employed as will be appreciated by one of ordinary skill in the art.

In some embodiments, the cooling medium (e.g., LN₂) from the refrigeration generator 18 may be additionally employed to spin a turbine blade attached to the anode disk assembly 5, a remotely controlled feathering valve, or similar control system, in conjunction with an RPM sensor to maintain the anode disk assembly 5 at a constant angular velocity. In this embodiment, the need for the motor 15 and drive 14 may be eliminated.

In some embodiments, one or more RPM, or similar functional sensors, may be employed to measure the rotational velocity of the anode disk assembly 5 and provide for computerized closed-loop control of the velocity to be at some constant optimized level to ensure maximum heat dissipation from the target spot 13 on the X-ray generation layer 8 by conduction of heat through the X-ray transparent support window 7. For example, a faster velocity may be better, but the velocity may depend on the ferrofluidic seal 4 design.

In some embodiments, the X-ray tube assembly 1 may employ an open-tube design requiring an actively pumped high-vacuum of at least 10⁻⁶ Torr in the electron path region. The high-vacuum may be achieved by employing a turbomolecular pump 24 backed by a roughing pump 26 and monitored by a high-vacuum gauge 21 that measures the vacuum environment of the vacuum area 3 in the body 2. Pump down operation may involve closing the air admit valve 22, closing the high-vacuum valve 23, and opening the backing valve 25 and roughing valve 27. The roughing pump 26 may then be activated until the tube body 2 is below 10 Torr at which time the turbomolecular pump 24 may be activated and the roughing valve 27 may be closed and the high-vacuum valve 23 opened. Once the high vacuum gauge 21 reads below 10⁻⁶ Torr, the HVPS 28 may be activated to begin X-ray production.

In some embodiments, the valves (e.g., air admit valve 22, high vacuum valve 23, backing valve 25, and roughing valve 27) may be electrically, pneumatically or otherwise remotely controlled by a programmable logic controller (PLC) or computer system, such as computing device 200 disclosed in more detail below, with some variation of the described requisite logic. In some embodiments, the HVPS 28, the motor 15, and high-vacuum sensor 21 may be controlled by the same or similar programmable logic controller (PLC) or computer system with some variation of the described requisite logic.

In some embodiments, the vacuum gauge 21 may represent at least one sensor for high vacuum based on technologies such as cold cathode (e.g., a Penning gauge) or hot cathode, but may be augmented with additional medium vacuum sensors such as a Pirani gauge (e.g., using a Wheatstone bridge) or thermocouple (e.g., using the Seebeck effect), controlled by a programmable logic controller (PLC) or a computer system, such as computing device 200 disclosed in more detail below, with some variation of the described requisite logic.

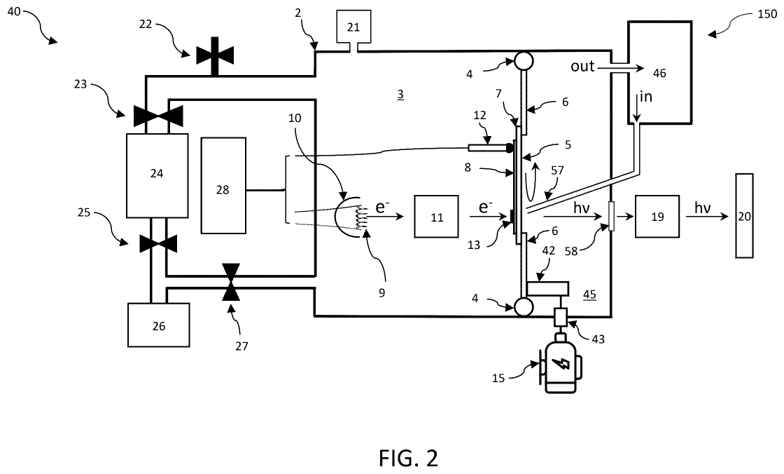

FIG. 2 illustrates an X-ray tube assembly 40 having a closed-loop cooling system 150 in accordance with some embodiments. X-ray tube assembly 40 may be similar to X-ray tube assembly 1 disclosed herein, and thus similar functions and parts are not repeated herein for brevity. X-ray tube assembly 40 may include a drive mechanism 42 and a rotary feedthrough 43 such that the motor 15 can rotate the anode disk assembly 5 within a second compartment 45 defined by the tube body 2. The second compartment 45 of the X-ray tube assembly 40 may be configured to maintain a pressurized environment. The tube body 2 of X-ray tube assembly 40 may include a transparent X-ray window 58 oriented in the X-ray beam path between the second compartment 45 and the space external to the X-ray tube assembly 40.

In some embodiments, the X-ray window 58 may include a variety of pressure resistant, X-ray transparent materials, such as beryllium (Be) metal foil, boron (B) doped beryllium (Be) foil (e.g., Moxtek DuraBeryllium), aluminum (Al) foil, magnesium (Mg) foil, CVD diamond, single crystal diamond, polymer (e.g., Moxtek AP3.3), other allotropes of carbon like graphite or graphene, silicon nitride, and advanced engineered X-ray windows (e.g., Amptek C-series). In some embodiments, the X-ray window 58 may be supported on either or both sides by some (low percentage coverage, e.g., less than 50%) rigid or semi-rigid grid or truss structure as needed against failure caused by high pressures induced by operation of the closed-loop cooling system 150.

In some embodiments, active closed-cycle cooling of the target spot 13 on the X-ray generation layer 8 may be achieved by conduction of heat through the X-ray transparent support window 7 where the heat may be removed by a stream of a cooling medium, such as chilled or cryogenic, gas or liquid directly impinging onto the external, non-vacuum side of the anode disk assembly 5.

The cooling system 150 may include a refrigerator 46 and dispenser 57. The terms cryo-refrigerator and cryocooler are used interchangeably, as are the terms in closed-circuit and closed-loop. In some embodiments, the closed-loop cooling system 150 may be used to cool the support window 7 through the dispenser 57 aimed at the external, non-vacuum side of the anode disk assembly 5 opposite the X-ray emitting target spot 13. For example, the cooling system 150 may be a closed-loop refrigeration cycle or similar cryocooler. This cooling may occur with or without phase change to cryogenic helium (He_{g}) gas, providing up to 600 W of cooling down to approximately 20-25K according to some embodiments. In some embodiments, the closed circuit refrigerator 46 may be a Stirling or a Gifford McMahon (GM) cycle refrigerator. It will be appreciated that other cooling systems and cycles may be used, such as pulse-tubes and Joule-Thompson coolers. In some embodiments, a cooling system from Bluefors Oy of Helsinki, Finland may be used. In some embodiments, a cooling system from Oxford Cryosystems of Oxford, UK may be used.

In some embodiments, the cryo-refrigerator 46 may be a closed-circuit liquid nitrogen (LN₂) system. This cooling can occur with or without phase change to cryogenic nitrogen (N_{2g}) gas, providing cooling down to approximately 77K according to some embodiments. In some embodiments, the closed-loop cooling system 150 may include a LN₂ cryo-refrigerator from Stirling Cryogenics of Eindhoven, Netherlands.

In some embodiments, the closed-loop cooling system 150 may be a closed-circuit Carnot or similar cycle cryo-refrigerator. This cooling may occur with phase change from a liquid to gas and may employ a variety of cooling media (e.g., anhydrous ammonia, fluorocarbons, hydrocarbons, CO₂, etc.) to providing cooling down to approximately 125-273K according to some embodiments. For example, a cooling system from Edwards Vacuum of Burgess Hill, UK may be used.

It is noted that the use of nitrogen and other non-helium cooling media may result in both X-ray flux attenuation and the production of parasitic characteristic X-ray lines in the resulting X-ray beam (hv) as observed by the X-ray optic 19. However, minimizing the distance between the X-ray emitting target spot 13 on the anode and the X-ray transparent exit window 58 may reduce the X-ray attenuation losses and parasitic characteristic X-ray lines from atomic elements comprising the coolant media.

The dispenser 57 may focus the cold stream onto a small region on the cooling system 150 side of the X-ray transparent support window 7, across from location of the target spot 13 on the X-ray generation layer 8 where the resulting tight spatial alignment of the dispenser 57 and target spot 13 may result in heat removal without blocking the generated X-rays (hv) from X-ray exit window 58 and subsequently the X-ray optic 19 and sample 20.

In some embodiments, the status of the cooling system 150, together with the flow rate and pressure of the cooling media, may be monitored (e.g., in real-time) by one or more sensors connected to and controlled by a programmable logic controller (PLC) or computer system, such as computing device 200 disclosed in more detail below, to ensure a consistent adequate cooling stream and to provide for emergency stop of the X-ray tube assembly 40 should a cooling malfunction occur.

In some embodiments, the anode disk assembly 5 may be spun to some high revolutions per minute (RPM) by the combination of the motor 15 and drive mechanism 42 (e.g., one or more gears or transmission). The motor 15 and drive mechanism 42 may be configured to operate for extended periods of time, up to nearly a 100% duty cycle between regularly scheduled maintenance. In some embodiments, the motor 15 may be disposed outside of the X-ray tube body 2 with connection to the drive mechanism 42 in the pressurized environment of the second compartment 45 via a pressure resistant rotary feedthrough 43. For example, the rotary feedthrough 43 may be from FerroTec Corporation of Tokyo, Japan. In other embodiments, the motor 15 and associated drive mechanism 42 may be located within the X-ray tube body 2, either in the vacuum area 3 or the pressurized environment of the second compartment 45.

It will be appreciated that the motor 15 may be electric, turbine, pneumatic, magnetic, hydraulic, etc. It will also be appreciated that the gearing (i.e., the drive mechanism 42) may be vane type, rack-and-pinion, helical or some other type. Flex couplings and friction couplings may also be employed. In some embodiments, status of any rotational drive system (e.g., motor 15), together with the rotational velocity, may be monitored in real-time by one or more sensors connected to and controlled by a programmable logic controller (PLC) or computer system, such as computing device 200 disclosed in more detail below. This may ensure consistent and adequate cooling, and may provide for emergency shutdown of the X-ray tube assembly 40 should a malfunction occur.

In some embodiments, the cooling media ejected by the dispenser 57 may be additionally employed to spin a turbine blade attached to the anode disk assembly 5. A remotely controlled feathering valve, or similar control system, may be used in conjunction with an RPM sensor to maintain the anode disk assembly 5 at a constant angular velocity, which may eliminate the need for the motor 15 and drive mechanism 42.

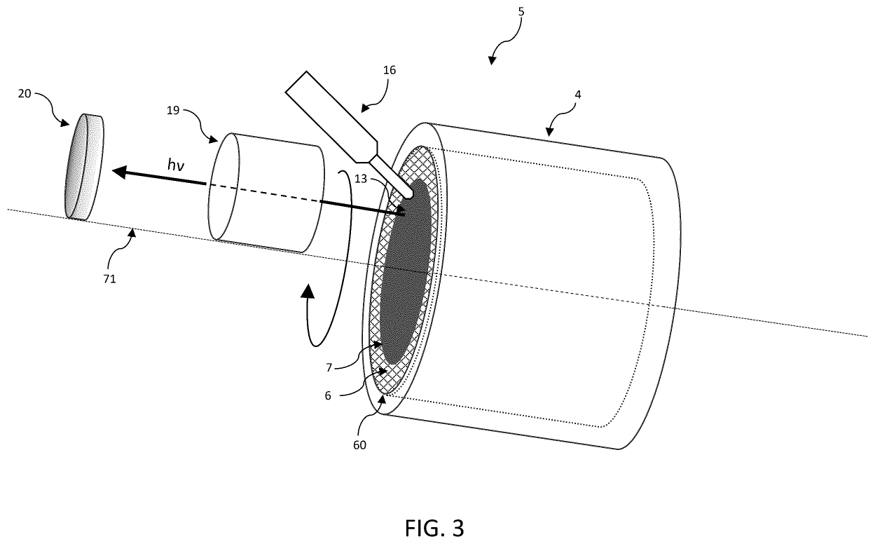

FIG. 3 illustrates a perspective view of a portion of an X-ray tube assembly 1, 40 in accordance with some embodiments. As discussed above, the anode disk assembly 5 may be configured to rotate a high velocity. The rotation of the anode disk assembly 5 may be facilitated by a ferrofluidic seal 4. The anode disk assembly 5 may include an inner bearing race 60 and the insulating ring 6. The insulating ring 6 may be made of a ceramic material. As discussed above, the support window 7 may be cooled by cooling system 100 or 150 through a nozzle 16 or dispenser 57 depending on the type of cooling system 100, 150.

In some embodiments, the anode disk assembly 5 may be a cylindrical multi-part device composed of a thermally insulating ring 6 (or annulus) high-vacuum bonded to the inner bearing race 60 of wide-bore, hollow-shaft, ferrofluidic seal 4 feedthrough on the outside of the ring 6 while the inner portion of the ring 6 may be high-vacuum bonded to the X-ray transparent support window 7 to complete the vacuum seal.

As discussed above, the target spot 13 on the backside of the X-ray transparent support window 7 may be located at a distance (in some embodiments, as far as possible) from the centerline 71 of the wide-bore, hollow-shaft, ferrofluidic seal 4 feedthrough so as to provide maximum integrated target area, and hence maximum conduction and dissipation of heat. Although FIG. 3 is illustrated as being part of X-ray tube assembly 1, it will be appreciated that it can also illustrated X-ray tube assembly 40. For example, nozzle 16 may be dispenser 57 and there may be an X-ray exit window 58 between the anode disk assembly 5 and the optics 19.

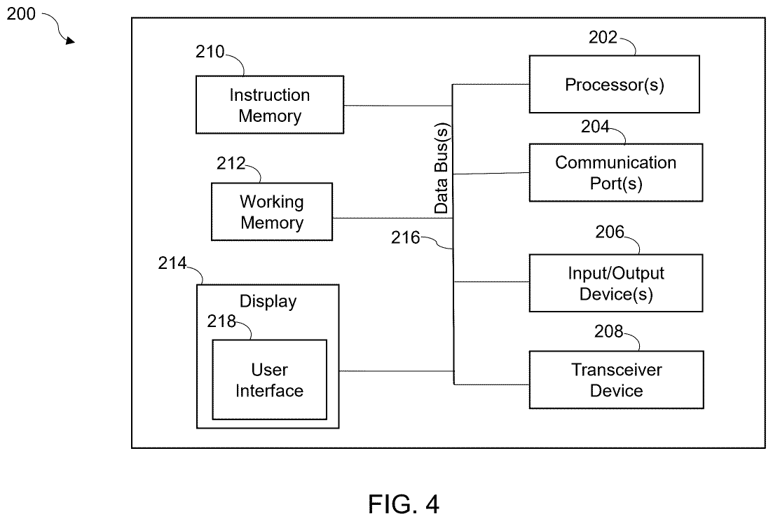

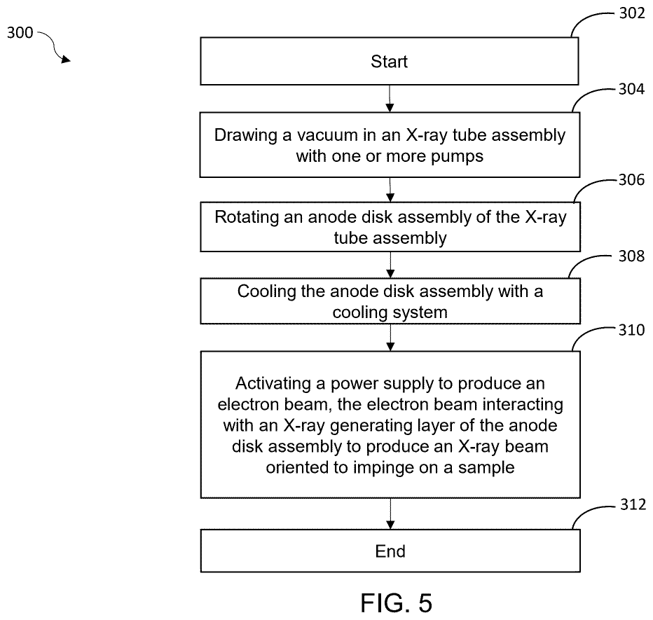

FIG. 4 illustrates a block diagram of an exemplary computing device 200 of the X-ray tube assembly 1, 40 in accordance with some embodiments. The computing device 200 can be employed by a disclosed system or used to execute a disclosed method of the present disclosure. For example, computing device 200 may be configured to operate any of the systems illustrated in FIGS. 1-3 or at least a portion of the method illustrated in FIG. 5. It should be understood, however, that other computing device configurations are possible.

Computing device 200 may include one or more processors 202, one or more communication port(s) 204, one or more input/output devices 206, a transceiver device 208, instruction memory 210, working memory 212, and optionally a display 214, all operatively coupled to one or more data buses 216. Data buses 216 may allow for communication among the various devices, processor(s) 202, instruction memory 210, working memory 212, communication port(s) 204, and/or display 214. Data buses 216 may include wired, or wireless, communication channels. Data buses 216 may connected to one or more devices.

Processor(s) 202 may include one or more distinct processors, each having one or more cores. Each of the distinct processors 202 may have the same or different structures. Processor(s) 202 may include one or more central processing units (CPUs), one or more graphics processing units (GPUs), application specific integrated circuits (ASICs), digital signal processors (DSPs), and the like.

Processor(s) 202 may be configured to perform a certain function or operation by executing code, stored on instruction memory 210. For example, processor(s) 202 may be configured to perform one or more of any function, method, or operation disclosed herein.

Communication port(s) 204 may include, for example, a serial port such as a universal asynchronous receiver/transmitter (UART) connection, a Universal Serial Bus (USB) connection, or any other suitable communication port or connection. In some examples, communication port(s) 204 may allow for the programming of executable instructions in instruction memory 210. In some examples, communication port(s) 204 may allow for the transfer, such as uploading or downloading, of data. In some embodiments, a wired or wireless fieldbus or Modbus protocol may be used.

Input/output devices 206 may include any suitable device that allows for data input or output. For example, input/output devices 206 may include one or more of a keyboard, a touchpad, a mouse, a stylus, a touchscreen, a physical button, a speaker, a microphone, or any other suitable input or output device.

Transceiver device 208 can allow for communication with a network, such as a Wi-Fi network, an Ethernet network, a cellular network, radio signals, Bluetooth, or any other suitable communication network. For example, if operating in a cellular network, transceiver device 208 may be configured to allow communications with the cellular network. Processor(s) 202 may be operable to receive data from, or send data to, a network via transceiver device 208.

Instruction memory 210 may include an instruction memory 210 that may store instructions that can be accessed (e.g., read) and executed by processor(s) 202. For example, the instruction memory 210 may be a non-transitory, computer-readable storage medium such as a read-only memory (ROM), an electrically erasable programmable read-only memory (EEPROM), flash memory, a removable disk, CD-ROM, any non-volatile memory, or any other suitable memory with instructions stored thereon. For example, the instruction memory 210 may store instructions that, when executed by one or more processors 202, cause one or more processors 202 to perform one or more of the operations of the X-ray tube assembly 1, 40.

In addition to instruction memory 210, the computing device 200 may also include a working memory 212. Processor(s) 202 may store data to, and read data from, the working memory 212. For example, processor(s) 202 may store a working set of instructions to the working memory 212, such as instructions loaded from the instruction memory 210. Processor(s) 202 may also use the working memory 212 to store dynamic data created during the operation of computing device 200. The working memory 212 may be a random access memory (RAM) such as a static random access memory (SRAM) or dynamic random access memory (DRAM), or any other suitable memory.

Display 214 may be configured to display user interface 218. User interface 218 may enable user interaction with computing device 200. In some examples, a user may interact with user interface 218 by engaging input/output devices 206. In some examples, display 214 may be a touchscreen, where user interface 218 may be displayed on the touchscreen.

FIG. 5 illustrates a block diagram of an exemplary method 300 of X-ray generation in accordance with some embodiments. The method 300 may start at block 302. At block 304, the method 300 may comprise drawing a vacuum in an X-ray tube body 2 with one or more pumps 24, 26. Block 306 may comprise rotating an anode disk assembly 5 of the X-ray tube assembly 1, 40. Block 308 may comprise cooling the anode disk assembly 5 with a cooling system 100, 150. Block 310 may comprise activating a HVPS 28 to produce an electron beam (e⁻), the electron beam (e−) interacting with an X-ray generation layer 8 of the anode disk assembly 5 to produce an X-ray beam (hv) oriented to impinge on a sample 20. The method 300 may end at block 312.

In some embodiments, the method 300 may include focusing the electron beam with a focusing cup 10. In some embodiments, the method 300 may include steering the electron beam with optics 11 disposed in the path of the electron beam. In some embodiments, the method 300 may include securing power to the X-ray tube assembly 1, 40 in response to a loss of cooling of the cooling system 100, 150.

### Features of the Disclosure

In some embodiments, a method for generating X-ray radiation may include providing a transmission anode target rotating anode X-ray vacuum tube with, but not limited to, micro-scale focal spots where the thin X-ray generating target layer anode may be affixed to a thermally conductive rotating substrate window disk that may be transparent to X-rays. The method may also include directing at least one electron beam onto a target spot on the outermost useful radius of the rotating X-ray generating target layer where the electron beam interacts with the moving target layer to generate X-radiation that passes through the substrate disk to be employed for work or further refined, monochromatized, diffused or focused by some X-ray optical train prior to utilization for work. The method may also include providing a target layer that has sufficiently high angular velocity and cryogenic cooling, in the area adjacent to the electron interaction target, in order for the X-ray emissions to be generated without destructive heating and ablation of the X-ray generating target layer. Heat may be removed from the anode target layer via rapid conduction and spread of said heat through the X-ray generating target layer anode and through the X-ray transparent support substrate, facilitated by the application of cryogenic gas or liquid to the non-vacuum facing surface of said substrate. The method may also include controlling the high energy electron beam, accelerated by a high voltage electric field ranging from 3 kV to about 500 KV, to interact with the target layer at an intensity such that Bremßtrahlung and characteristic line emissions are generated in the X-ray energy region.

In some embodiments, a rotating anode disk X-ray source may include an X-ray tube vacuum envelope incorporating a rotational wide bore hollow vacuum feedthrough assembly. The rotating anode disk X-ray source may include at least one cathode assembly positioned within said X-ray tube high vacuum envelope for the production of free electrons. The cathode assembly may include a filament, which may be tungsten (W), that may be resistively heated by electrical current flow to a point where electrons will boil off under the influence of an accelerating electrical potential in a vacuum. The cathode assembly may include a cold (cathode) field-emission electron gun (CFEG) that emits electrons from a tungsten tip emitter, or other suitable material like carbon nanotubes (CNT) or gallium-doped zinc oxide (GZO)-coated CNT emitters, by tunneling the potential barrier (e.g., ˜4.5 eV for W) where the emitter may be in a vacuum and kept at near room temperature in a strong electric field. The cathode assembly may include a focusing cup where negatively charged, shallow depression on the surface of or behind the cathode that concentrates, focuses and accelerates the electron beam towards the focal spot of the anode. The rotating anode disk X-ray source may include a singular or multiple electron optics assembly(s) located between the cathode assembly and rotating anode disk to create at least one electron beam controlling electromagnetic field designed to focus the electron beam actively or passively into a spatially stable defined shape and size spot with stable emission current on the X-ray generating layer anode of the rotating disk assembly. In some embodiments, an active electron beam control may be based on a feedback loop from the output of a secondary electron (SE) detector inside of the X-ray tube assembly. In some embodiments, an active electron beam control may be based on a feedback loop from the output of an X-ray detector outside of the X-ray tube assembly. In some embodiments, passive electron beam control may be accomplished with an electrified grid to create a desirable constant electromagnetic field to stabilize the electron beam.

The rotating anode disk X-ray source may further include an integrated HVPS to both resistively heat the cathodic filament and to provide a cathode to anode electrical potential of between 3 kV and about 500 kV in order to accelerate electrons toward the X-ray generating layer target on the transmission anode assembly. In some embodiments, the process of power transmission in rotating electrical connectors begins at the HVPS source attached to the stationary part of the tube assembly. Electrically conductive brushes, which may be made from carbographitic, electrographitic, soft graphite, metal graphite, and Bakelite-graphite materials, are also connected to the stationary part. From the source, the high voltage enters the brushes or slip ring, which are maintained in constant contact with the conductive track or ring area on the rotating anode X-ray generating layer. In some embodiments, as the rotating anode spins, the high voltage may be transferred via the rotating conductive tracks to the rotating anode of the system. This mechanism allows for the transmission of electrical power between components, regardless of their motion relative to each other. Component rotation and power transmission may occur simultaneously without interference.

The rotating anode disk X-ray source may further include a rotating transmission target anode assembly positioned within said X-ray tube vacuum envelope. The rotating transmission anode assembly may include an X-ray transparent anode substrate window. The rotating transmission anode assembly may include an X-ray generation layer disposed on the vacuum side of the anode substrate. The X-ray generation layer may be configured to receive an electron beam from the cathode assembly and emit X-rays through said anode substrate. The rotating transmission anode assembly may include a cooling mechanism configured to continuously remove heat from the non-vacuum facing surface of said anode substrate. The anode substrate and X-ray generating layer may be configured to rapidly rotate during operation to create a large target swept area, distributing heat and reducing beam ablation of the target layer from the impingement of electrons. In some embodiments, high voltage at the X-ray generation layer anode may be maintained by a high voltage slip ring or similar electro-mechanical mechanism, such as a rotary electrical connector, a rotating connector, a slip ring rotating connector, a rotating cable connector, a swivel wire connector, a rotary joint electrical connector, a rotating power connector, a rota connector, a slip ring rotary joint electrical connector, or a rotating electrical connector slip ring. As an example, the connector may be a connector provided by Meridian Laboratory of Middleton, WI.

In some embodiments, the X-ray generating target may be a thin layer, composed of a refractory or near-refractory metal with a high melting point, such as niobium (Nb), chromium (Cr), molybdenum (Mo), tantalum (Ta), tungsten (W), rhenium (Re), vanadium (V), hafnium (Hf), titanium (Ti), zirconium (Zr), ruthenium (Ru), osmium (Os), rhodium (Rh), silver (Au), gold (Au), palladium (Pd), copper (Cu), iron (Fe), cobalt (Co) and iridium (Ir), and alloyed or layered combinations thereof. In some embodiments, the anode X-ray generating layer may be between ≤100 nm to ≥100 μm thick and may be attached to a rigid, vacuum compatible, high thermal conductivity X-ray transparent substrate. In some embodiments, the X-ray transparent substrate may be made of an allotrope of carbon like diamond, graphite, graphene and graphene-like sheet made from fullerenes. In some embodiments, the anode X-ray emitting material may be thick enough (≥100 μm) that it may be self-supporting in and of itself, requiring no support substrate. In some embodiments, the X-ray transparent support substrate may be a beryllium (Be) material, a composite, be manufactured, or may be composed of one or more synthetic materials. In some embodiments, the X-ray generating anode layer and X-ray transparent support window may either or both be manufactured from thermally conductive metamaterials. In some embodiments, the X-ray transparent support substrate may be fabricated from silicon carbide, beryllium oxide, aluminum nitride or aluminum oxide, and may serve as a low cost substrate option for low power, high energy applications. In some embodiments, the X-ray transparent support substrate may be supported on the outside (non-vacuum side) by some (low percentage coverage) rigid or semi-rigid grid or truss structure as needed against failure caused by pressure differentials between the vacuum environment inside the X-ray tube body and the external atmosphere.

In some embodiments, a cooling system may be configured to use a cryogenic fluid, such as liquid nitrogen or liquid air, directed at the non-vacuum side of the X-ray transparent support substrate opposite the electron beam target position to efficiently remove heat from the anode substrate by vaporization phase change to a gas (enthalpy of vaporization). In some embodiments, the cooling system may operate in an open-loop configuration where the resulting gaseous cryogen may be vented to the local environment. In some embodiments, the cooling system may operate in a closed-cycle configuration, as required for liquid helium, where a cryogen recovery system may be employed to recover and reliquefy the gas for immediate reuse.

In some embodiments, the anode substrate and the X-ray generation layer may be configured such that both an anode inclination angle and an X-ray emission angle are approximately zero degrees. In some embodiments, the rotating anode disk assembly may be spun at high revolutions per unit time to increase the surface area available for heat dissipation. In some embodiments, the X-ray generating target layer anode may be circular or annular in shape and may include a support structure and made of diamond materials optimized for heat spreading and structural integrity. In some embodiments, the rotating anode disk X-ray source may include a vacuum system, which may include a turbomolecular pump, various valves, a backing or roughing pump, various vacuum seals and rotating ferrofluidic seals to create and maintain high vacuum conditions within the X-ray tube. In some embodiments, the rotating anode disk X-ray source may include at least one sensor for high vacuum based on technologies, such as cold cathode or hot cathode, but may be augmented with additional medium vacuum sensors like Pirani or thermocouple. In some embodiments, the vacuum system may be controlled by a programmable logic controller (PLC) or computer system. In some embodiments, the system may be configured to emit X-rays suitable for applications, such as medical diagnostics, non-destructive testing, lithography, microscopy, computed tomography, medical and industrial radiography, materials science, semiconductor metrology, X-ray crystallography, X-ray fluorescence, and X-ray diffraction.

In addition, the methods and system described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

In this application, including the definitions below, the term “module” or the term “controller” may be replaced with the term “circuit.” The term “module” may refer to, be part of, or include processor hardware (shared, dedicated, or group) that executes code and memory hardware (shared, dedicated, or group) that stores code executed by the processor hardware.

The module may include one or more interface circuits. In some examples, the interface circuit(s) may implement wired or wireless interfaces that connect to a local area network (LAN) or a wireless personal area network (WPAN). Examples of a LAN are Institute of Electrical and Electronics Engineers (IEEE) Standard 802.11-2016 (also known as the WIFI wireless networking standard) and IEEE Standard 802.3-2015 (also known as the ETHERNET wired networking standard). Examples of a WPAN are the BLUETOOTH wireless networking standard from the Bluetooth Special Interest Group and IEEE Standard 802.15.4.

The module may communicate with other modules using the interface circuit(s). Although the module may be depicted in the present disclosure as logically communicating directly with other modules, in various implementations the module may actually communicate via a communications system. The communications system includes physical and/or virtual networking equipment such as hubs, switches, routers, and gateways. In some implementations, the communications system connects to or traverses a wide area network (WAN) such as the Internet. For example, the communications system may include multiple LANs connected to each other over the Internet or point-to-point leased lines using technologies including Multiprotocol Label Switching (MPLS) and virtual private networks (VPNs).

It may be emphasized that the above-described embodiments, particularly any “preferred” embodiments, are merely possible examples of implementations, set forth for a clear understanding of the principles of the disclosure. Many variations and modifications may be made to the above-described embodiments of the disclosure without departing substantially from the spirit and principles of the disclosure. All such modifications and variations are intended to be included herein within the scope of this disclosure.

While this specification contains many specifics, these should not be construed as limitations on the scope of any disclosures, but rather as descriptions of features that may be specific to a particular embodiment. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments.

Although the invention has been described in terms of exemplary embodiments, it is not limited thereto. Rather, the appended claims should be construed broadly, to include other variants and embodiments of the invention, which may be made by those skilled in the art without departing from the scope and range of equivalents of the invention.

What is claimed is:

1. A system comprising:
an X-ray tube assembly having an anode disk assembly;
a motor configured to rotate the anode disk assembly;
one or more pumps configured to draw a vacuum in the X-ray tube assembly; and
an open-loop cooling system configured to cool the anode disk assembly.

2. The system of claim 1, wherein the anode disk assembly comprises a support window made of a metal material such that the support window is configured to generate X-rays from an electron beam incident on the support window.

3. The system of claim 1, wherein the anode disk assembly comprises:
a support window; and
an X-ray generating layer having a target spot.

4. The system of claim 3, further comprising:
a power supply; and
a slip ring coupled to the X-ray generating layer,
wherein the power supply is configured to provide power to a filament cathode of the X-ray tube assembly and the slip ring.

5. The system of claim 3, wherein the open-loop cooling system comprises:
a nozzle;
a refrigeration generator; and
a tube coupling the nozzle to the refrigeration generator,
wherein the nozzle provides a cooling medium to a surface of the support window from the refrigeration generator.

6. The system of claim 1, wherein the X-ray tube assembly is oriented such that an anode inclination (AI) and and an X-ray emission (XE) angle are both zero degrees.

7. The system of claim 1, wherein the X-ray tube assembly comprises a ferrofluidic seal configured to maintain the vacuum in the X-ray tube assembly while the anode disk assembly is rotating.

8. The system of claim 1, wherein the anode disk assembly comprises:
an inner bearing race; and
an insulating ring, the insulating ring being vacuum bonded to the inner bearing race and a support window of the anode disk assembly.

9. A system comprising:
an X-ray tube assembly having an anode disk assembly;
a motor configured to rotate the anode disk assembly;
one or more pumps configured to draw a vacuum in the X-ray tube assembly; and
a closed-loop cooling system configured to cool the anode disk assembly.

10. The system of claim 9, wherein the anode disk assembly comprises a support window made of a metal material such that the support window is configured to generate X-rays from an electron beam incident on the support window.

11. The system of claim 9, wherein the anode disk assembly comprises:
a support window; and
an X-ray generating layer having a target spot.

12. The system of claim 11, further comprising:
a power supply; and
a slip ring coupled to the X-ray generating layer,
wherein the power supply is configured to provide power to a filament cathode of the X-ray tube assembly and the slip ring.

13. The system of claim 11, wherein the closed-loop cooling system comprises:
a refrigerator; and
a dispenser coupled to the refrigerator;
wherein the dispenser provides a cooling medium to a surface of the support window from the refrigerator, and
wherein the X-ray tube assembly is configured such that the cooling medium is directed back to the refrigerator after being dispensed by the dispenser.

14. The system of claim 9, wherein the X-ray tube assembly is oriented such that an anode inclination (AI) and an X-ray emission (XE) angle are both zero degrees.

15. The system of claim 9, wherein the X-ray tube assembly comprises a ferrofluidic seal configured to maintain the vacuum in the X-ray tube assembly while the anode disk assembly is rotating.

16. The system of claim 9, wherein the anode disk assembly comprises:
an inner bearing race; and
an insulating ring, the insulating ring being vacuum bonded to the inner bearing race and a support window of the anode disk assembly.

17. A method comprising:
drawing a vacuum in an X-ray tube assembly with one or more pumps;
rotating an anode disk assembly of the X-ray tube assembly;
cooling the anode disk assembly with a cooling system; and
activating a power supply to produce an electron beam, the electron beam interacting with an X-ray generating layer of the anode disk assembly to produce an X-ray beam oriented to impinge on a sample.

18. The method of claim 17, further comprising focusing the electron beam with a focusing cup.

19. The method of claim 17, further comprising steering the electron beam with optics disposed in a path of the electron beam.

20. The method of claim 17, further securing power to the X-ray tube assembly in response to a loss of cooling of the cooling system.
